(19) United States
(12) Patent Application Publication
(10) Pub. No.: US 2003/0104165 A1
(43) Pub. Date: Jun. 5, 2003

(54) Gliding or rolling board

(75) Inventors: Jean-Philippe Guex, Cran-Gevrier (FR); Serge Solviche, Cran-Gevrier (FR)

Correspondence Address: GREENBLUM & BERNSTEIN, P.L.C., 1941 Roland Clarke Place, Reston, VA, 20191, US

(73) Assignee: SALOMON S.A., Metz-Tessy (FR)

(21) Appl. No.: 10/304,867

(22) Filed: Nov. 27, 2002

(30) Foreign Application Priority Data
Nov. 30, 2001 (FR) 01.15804

(51) Int. Cl. B32B 5/12

(52) U.S. Cl. 428/113

(57) ABSTRACT

A gliding or rolling board, such as a snowboard, surfboard, ski, waterski, skateboard, or the like, having at least one reinforcement. The reinforcement has a first web of fibers oriented along an angle between about +15 and +28 degrees, the angle being measured with respect to the longitudinal direction of the board.

### CROSS-REFERENCE TO RELATED APPLICATION

This application is based upon French Patent Application No. 01.15804, filed Nov. 30, 2001, the disclosure of which is hereby incorporated by reference thereto in its entirety, and the priority of which is hereby claimed under 35 U.S.C. §119.

### BACKGROUND OF THE INVENTION

1. Field of the Invention

The invention relates to the field of gliding or rolling boards, such as those adapted for snowboarding, surfboarding, skiing, water skiing, skateboarding, or the like.

2. Description of Background and Relevant Information

A board according to prior art has a length measured along a longitudinal direction of the board, between a first end and a second end.

Generally, the board has a sandwich panel that extends along at least 50% of the board surface, the sandwich panel having a first reinforcement, a second reinforcement, and at least one core located between the first and second reinforcements. The core separates the reinforcements on both sides of the neutral plane of the panel. Each reinforcement gives the sandwich panel, and consequently the board, its mechanical strength.

In the boards according to the prior art, a reinforcement generally has a first web of fibers oriented along the longitudinal direction of the board, and a second web of fibers substantially perpendicular to the fibers of the first web.

The fibers are made of various materials, such as glass, carbon, polyamide, or the like. A binder maintains the fibers to form the reinforcement.

In order to obtain a sufficient mechanical strength of the board, particularly in flexion along a transverse axis and/or in torsion along a longitudinal axis, it is known to select the type of fibers and/or to add fibers to the sandwich panel over all or part of the surface. For example, juxtaposed strips can be added to the reinforcement. The fibers are oriented along the direction desired.

This addition does improve the mechanical strength, but it comes with an increase in the weight of the board. Also, an addition of fibers makes manufacturing the board more time-consuming and more complicated.

### SUMMARY OF THE INVENTION

The gliding or rolling board of the invention includes at least one reinforcement which contributes to improving the mechanical strength of the board in flexion along a transverse axis and/or in torsion along a longitudinal axis, without causing a simultaneous increase in the weight of the board.

To this end, the invention proposes a gliding or rolling board that has a length measured along a longitudinal direction of the board between a first end and a second end, the board having at least one reinforcement that extends along at least 50% of the surface of the board.

The reinforcement of the board according to the invention has a first web of fibers oriented along an angle between +15 and +28 degrees, the angle being measured with respect to the longitudinal direction of the board and along an axis substantially perpendicular to the board, the direction for measuring the angle being arbitrary.

This orientation of fibers, in the first web of the reinforcement, gives the board an accrued mechanical strength both in flexion along a transverse axis and in torsion along a longitudinal axis of the board. This accrued strength does not cause a substantial increase in the weight of the board.

It can be provided that the reinforcement have a second web of fibers oriented along an angle between −15 and −28 degrees, the angle being measured with respect to the longitudinal direction of the board and along an axis substantially perpendicular to the board, the direction for measuring the angle being the opposite of the direction for measuring the first web of fibers. The addition of a second web further improves the mechanical strength of the reinforcement for a given weight. The crossing of the fibers of the first and second webs improves the cohesion of the reinforcement and, in some cases, facilitates its manufacture.

Complementarily, it is still possible for the reinforcement to have a longitudinal web of fibers oriented substantially along the longitudinal direction of the board, in combination with one or with both of the first two webs. In this case, it is the flexional strength along a transverse axis of the board that is improved.

The invention also includes a method for manufacturing a gliding or rolling board, in which at least one reinforcement contributes to improving the mechanical strength without increasing the weight of the board.

### BRIEF DESCRIPTION OF DRAWINGS

Other features and advantages of the invention will be better understood from the following description, with reference to the attached drawings, showing by way of a non-limiting example how the invention can be embodied, and in which:

FIG. 1 is a perspective view of a board according to the example of embodiment of the invention;

FIG. 2 is a cross-sectional view along the line II-II of FIG. 1;

FIG. 3 is a diagram showing the structure of a reinforcement of the board according to a particular embodiment of the invention;

FIG. 4 is an open perspective view of the board according to the particular embodiment of the invention.

### DETAILED DESCRIPTION OF THE INVENTION

Although the following description relates to a snowboard, it is to be understood that the invention also relates to other boards adapted to sports, as previously mentioned.

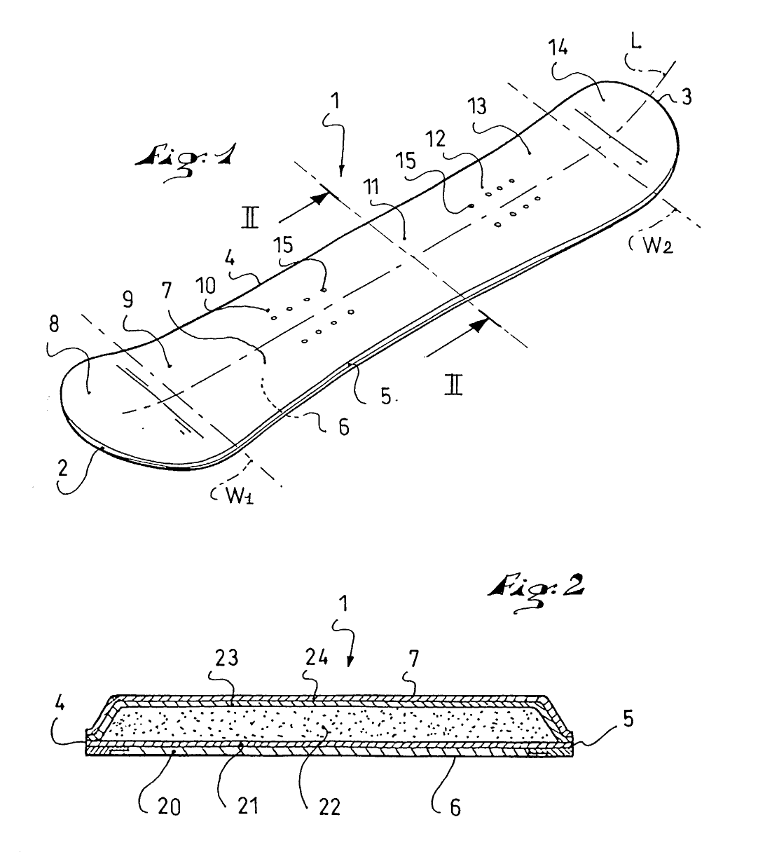

As known and as can be seen particularly in FIG. 1, a snowboard 1 has a length measured along a longitudinal direction L, between a first end 2 and a second end 3. The board 1 also has a width measured along a transverse direction, between a first lateral edge 4 and a second lateral edge 5, as well as a height measured between a gliding surface 6 and a support surface 7.

The transverse direction is perpendicular to the longitudinal direction L and parallel to the gliding surface 6.

The board 1 also has, from the first end 2 to the second end 3, a first end zone 8, a first contact line W1, a first intermediary zone 9, a first retention zone 10, a central zone 11, a second retention zone 12, a second intermediary zone 13, a second contact line W2, and a second end zone 14.

Each retention zone 10, 12 is provided to receive a device for retaining a user's foot, i.e., a binding for the user's boot. The devices, not shown, can be affixed to the board 1 by means such as screws. To this end, each retention zone 10, 12 can be provided with threaded holes 15.

Each of the contact lines W1, W2 is a line, substantially transverse to the board 1, in the area at which the gliding surface 6 touches a flat surface when the board 1 rests on the surface without an outside force/influence.

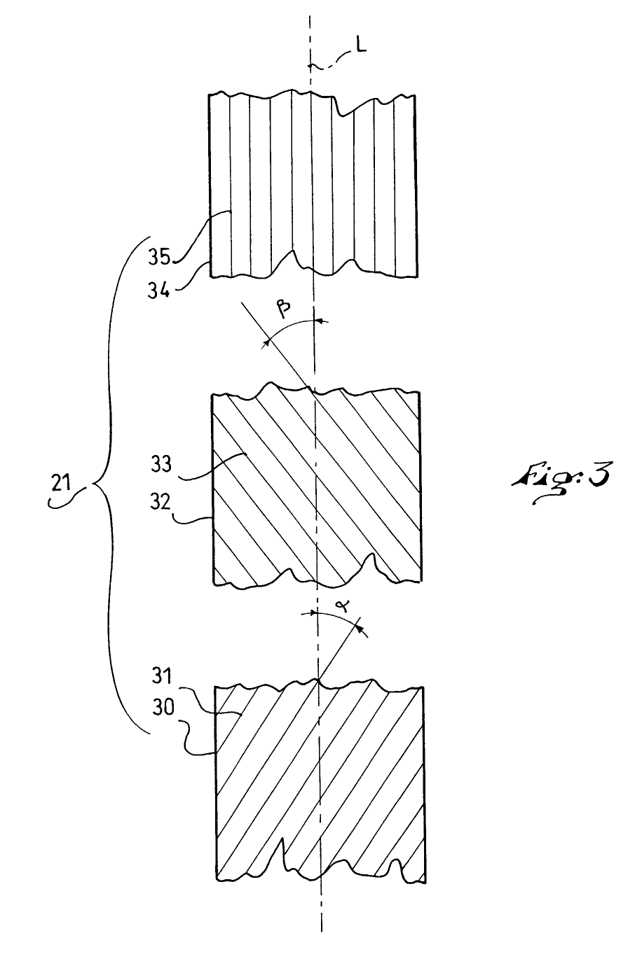

The height of the board 1 is seen in cross-section in FIG. 2.

From the gliding surface 6 to the support surface 7, the board 1 has a base 20, a first reinforcement 21, a core 22, a second reinforcement 23, and a protective layer 24.

The base 20 is manufactured, for example, with a plastic material containing polyethylene. The protective layer 24 is manufactured, for example, with a plastic material containing acetyl-butadiene-styrene.

Each of the reinforcements 21, 23 is preferably made from resin-impregnated fibers. The fibers can be made from any material, or from any combination of materials, such as glass, carbon, aramid, metal or the like. The core 22 is made from a low density material, such as wood or a synthetic foam, which imparts thereto a reduced mass. The simultaneous use of wood and of foam is possible.

The reinforcements 21, 23 and the core 22 form a sandwich panel that extends at least along 50% of the board surface, and preferably substantially over the whole surface. This makes the board structure homogenous.

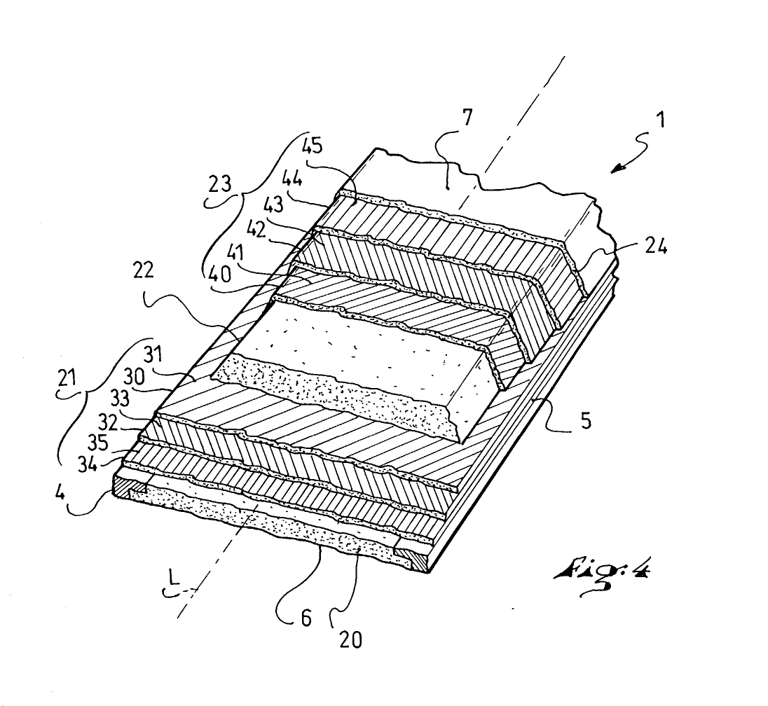

According to the invention and as seen in FIGS. 3 and 4, at least one of the reinforcements 21, 23 has three webs that are superimposed.

Arbitrarily, the diagram according to FIG. 3 relates to the first reinforcement 21, but it is to be understood that the diagram could relate to the second reinforcement 23.

The first reinforcement 21 has a first longitudinal web 30 of fibers oriented along an angle α, between +15 and +28 degrees, with respect to the longitudinal direction L. Lines 31 symbolize the orientation of the fibers. These lines 31 are not on scale with the fibers.

The first reinforcement 21 has a second web 32 of fibers oriented along an angle β, between −15 and −28 degrees, with respect to the longitudinal direction L. Lines 33 symbolize the orientation of the fibers.

The angles α and β are measured with respect to the longitudinal direction L of the board, along an axis substantially perpendicular to the reinforcement 21, the direction for measuring the angles α and β being arbitrary.

The first reinforcement 21 has a longitudinal web 34 of fibers oriented substantially along the longitudinal direction L of the reinforcement. The different lines 35 symbolize the orientation of the fibers.

Within each of the webs 30, 32, 34, the fibers are parallel one to the other, except for a manufacturing tolerance.

In order to manufacture the reinforcement 21, the three webs 30, 32, 34 of fibers are superimposed. The webs 30, 32, 34 are connected together, such as by being sewn together, to form a unitary element that will be called a complex throughout the remainder of the description. After being connected together, the webs 30, 32, 34 are impregnated with resin to form the reinforcement 21.

FIG. 4 shows the arrangement of the reinforcements 21, 23 to make the board 1. The first reinforcement 21 is shown with its three webs 30, 32, 34.

In comparison, the second reinforcement 23 has a first web 40 of fibers oriented along an angle, between +15 and +28 degrees, with respect to the longitudinal direction L. Lines 41 symbolize the orientation of the fibers.

The second reinforcement 23 has a second web 42 of fibers oriented along an angle, between −15 and −28 degrees, with respect to the longitudinal direction L. Lines 43 symbolize the orientation of the fibers.

Here again, the angles are measured with respect to the longitudinal direction of the board, along an axis substantially perpendicular to the reinforcement 23, the direction for measuring the angles being arbitrary.

The second reinforcement 23 has a longitudinal web 44 of fibers oriented substantially along the longitudinal direction L of the board. Here again, lines 45 symbolize the orientation of the fibers.

Once again, within each of the first 40, second 42 and third 44 webs, the fibers are parallel to one another, with the exception of the manufacturing tolerance.

For each of the first 21 and second 23 reinforcements, the fiber webs are juxtaposed in any order. However, it appears advantageous to have the two webs 30, 32, 40, 42, whose fibers are offset with respect to the longitudinal direction L, coupled together. This facilitates the manufacturing of the reinforcement and reduces costs.

Preferably, for each reinforcement 21, 23, the fibers of the first 30, 40 and second 32, 42 webs are oriented substantially along the same value of an angle α, β on both sides of the longitudinal direction L of the board. This aligns one of the three main inertia axes of the reinforcement along the longitudinal direction L. Consequently, the transverse flexional strength of the board 1 is symmetrical along a central longitudinal axis of the board 1. It follows advantageously that the behavior of the board 1 is the same during supports on one or the other of the first 4 and second 5 lateral edges.

Preferably, for each of the reinforcements 21, 23, the angles α and β of the orientation of the fibers of the first 30, 40 and second 32, 42 webs, with respect to the longitudinal direction L, are substantially equal to 22.5°. This angle value improves the flexional strength of the board 1 along a transverse axis, and also brings a good torsional strength. This is applicable regardless of the nature of the fibers.

Preferably, each complex of a reinforcement 21, 23 is made from glass fiber. This reduces the manufacturing costs compared to carbon or aramid, although the latter can be used.

A preferred selection of glass fibers is given hereinafter by way of a non-limiting choice.

The first 30, 40 and second 32, 42 webs of a reinforcement 21, 23 have a grammage on the order of 182 g/m², respectively. The longitudinal web 34, 44 of the reinforcement 21, 23 has a grammage on the order of 472 g/m². The thread for binding the webs weighs 17 g/m². In all, the complex of a reinforcement according to the invention has a grammage that approximates 853 g/m².

Another interesting selection of glass fibers provides a grammage of 82 g/m² for the first 30, 40 and second 32, 42 webs, and a grammage of 572 g/m² for the longitudinal web. This comes to a grammage approximating 753 g/m² with the binding thread.

In comparison, the complex of a board according to the prior art, made with two glass fiber webs perpendicular to one another, has a grammage of 875 g/m². This grammage is necessary for avoiding ill-timed ruptures of the reinforcements.

One could also provide a combined structure of the reinforcement. For example, the first 30, 40 and second 32, 42 webs are made of carbon with a grammage of 110 g/m², and the longitudinal web 34, 44 is made of glass with a grammage of 472 g/m². This comes to a grammage approximating 709 g/m² with the binding thread. Consequently, the board is even lighter and stronger.

The reinforcements 21, 23 of the board 1 according to the invention do not cause a substantial increase in the weight of the board 1. Rather, the opposite occurs.

Generally speaking, the board 1 according to the invention is manufactured in a conventional manner. The core 22 is made separately. The reinforcements 21, 23 are made separately, by stitching the three webs 30, 32, 34, 40, 42, 44 together, then by impregnating them with a resin. Next, the base 20, the first reinforcement 21, the core 22, the second reinforcement 23 and the protective layer 24 are stacked in a mold. Then a rise in temperature and pressure allows consolidating the board 1.

The invention is not limited to the specific example just described, and it encompasses all of the technical equivalents that can come within the scope of the following claims.

Particularly, each reinforcement can have webs of various types, or each web can have various types of fibers.

The first and second webs of a reinforcement, the fibers of which are angularly offset with respect to the fibers of the longitudinal web, can have interlaces of fibers to form a single web having interlaced fibers.

At least one sheet can be juxtaposed to each reinforcement 21, 23. The sheet is preferably made with a non-woven material made of fibers, such as glass fibers. This facilitates handling the reinforcement for positioning in the mold, and allows a resin to be applied during consolidation.

What is claimed is:

1. A gliding or rolling board comprising:
a first end and a second end;
a length measured along a longitudinal direction between the first end and the second end;
at least one reinforcement extending along at least 50% of a surface of the board, the reinforcement comprising a first web of fibers oriented along an angle comprised between +15 and +28 degrees, the angle being measured with respect to the longitudinal direction of the board and along an axis substantially perpendicular to the board, the direction for measuring the angle being arbitrary.

2. A gliding or rolling board according to claim 1, wherein:
the angle between +15 and +28 degrees being a first angle;
the reinforcement further includes a second web of fibers oriented along a second angle, said second angle comprising between −15 and −28 degrees, the second angle being measured with respect to the longitudinal direction of the board and along an axis substantially perpendicular to the board, the direction for measuring the second angle being opposite of the direction for measuring the first web of fibers.

3. A gliding or rolling board according to claim 1, wherein:
the reinforcement has a longitudinal web of fibers oriented substantially along the longitudinal direction of the board.

4. A gliding or rolling board according to claim 2, wherein:
the fibers of the first and second reinforcement webs are oriented substantially along the same value of an angle on both sides of the longitudinal direction of the board.

5. A gliding or rolling board according to claim 2, wherein:
the first and second angles for orienting the fibers of the first and second webs, with respect to the longitudinal direction, are substantially equal to 22.5°.

6. A gliding or rolling board according to claim 1, wherein:
the three webs of the reinforcement are made from glass fibers.

7. A gliding or rolling board according to claim 3, wherein:
the longitudinal web of a reinforcement has a grammage on the order of 472 g/m²; and
the first and second webs have a grammage on the order of 182 g/m².

8. A gliding or rolling board according to claim 3, wherein:
the three webs of a reinforcement are sewn together.

9. A gliding or rolling board according to claim 1, wherein:
a sheet is juxtaposed to the reinforcement.

10. A gliding or rolling board according to claim 1, wherein:
a core is located between the reinforcements.

11. A gliding or rolling board according to claim 10, wherein:
the core is made from a low density material.

12. A gliding or rolling board according to claim 1, further comprising:
a base and a protective layer.
